(19) United States
(12) Patent Application Publication
(10) Pub. No.: US 2022/0398606 A1
(43) Pub. Date: Dec. 15, 2022

(54) SHOPPING TRACKING ASSEMBLY

(71) Applicant: John Austin, Humble, TX (US)

(72) Inventor: John Austin, Humble, TX (US)

(21) Appl. No.: 17/344,948

(22) Filed: Jun. 11, 2021

(51) Int. Cl. G06Q 30/02; G06Q 30/06

(52) U.S. Cl. CPC G06Q 30/0201; G06Q 30/0601

(57) ABSTRACT

A shopping tracking assembly includes a data server that stores a list of items being sold in a retail environment. A panel is included that is attachable to a shopping cart, and a housing is coupled to the panel. A tracking unit is integrated into the housing and the tracking unit is in wireless communication with a tracking device on a retail item that is placed into the shopping car. The tracking unit is in wireless communication with the data server thereby facilitating the data server to compile a list of each retail item that has been place into the shopping cart. Moreover, the data server communicates the list of each retail item to a point of sale device to inhibit any retail item from being removed from the retail environment without paying for the retail item.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to tracking devices and more particularly pertains to a new tracking device for tracking retail items placed into a shopping cart. The tracking device includes a transceiver that is in wireless communication with a tracker on the retail item and a transmitter that broadcasts the identity of the retail item. Additionally, a point of sale device receives a list of the retail items in the shopping cart to ensure every retail item is either purchased or returned.

### (2) Description of Related Art Including Information Disclosed Under 37 CFR 1.97 and 1.98.

The prior art relates to tracking devices including a variety of electronic shopping devices for tracking and subsequently reconciling retail items placed into a shopping cart. In several instances the electronic shopping devices include a bar code scanner, and the electronic shopping devices tabulate pricing of the retail items placed into the shopping cart. In no instance does the prior art disclose a triangular panel that is mounted to a shopping cart and a tracking unit integrated into the triangular panel for tracking retail items placed into the shopping cart.

### BRIEF SUMMARY OF THE INVENTION

An embodiment of the disclosure meets the needs presented above by generally comprising a data server that stores a list of items being sold in a retail environment. A panel is included that is attachable to a shopping cart, and a housing is coupled to the panel. A tracking unit is integrated into the housing and the tracking unit is in wireless communication with a tracking device on a retail item that is placed into the shopping car. The tracking unit is in wireless communication with the data server thereby facilitating the data server to compile a list of each retail item that has been place into the shopping cart. Moreover, the data server communicates the list of each retail item to a point of sale device to inhibit any retail item from being removed from the retail environment without paying for the retail item.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a shopping tracking assembly according to an embodiment of the disclosure.

FIG. 2 is a front phantom view of an embodiment of the disclosure.

FIG. 3 is a back view of an embodiment of the disclosure.

FIG. 4 is a left side view of an embodiment of the disclosure.

FIG. 5 is a perspective in-use view of an embodiment of the disclosure.

### DETAILED DESCRIPTION OF THE INVENTION

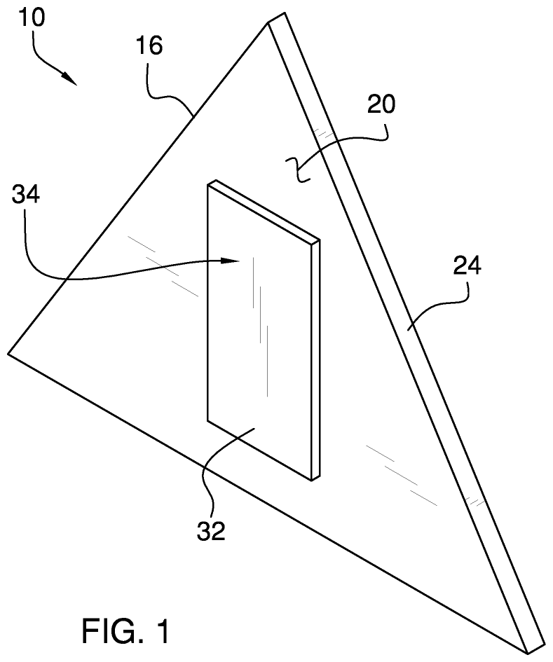

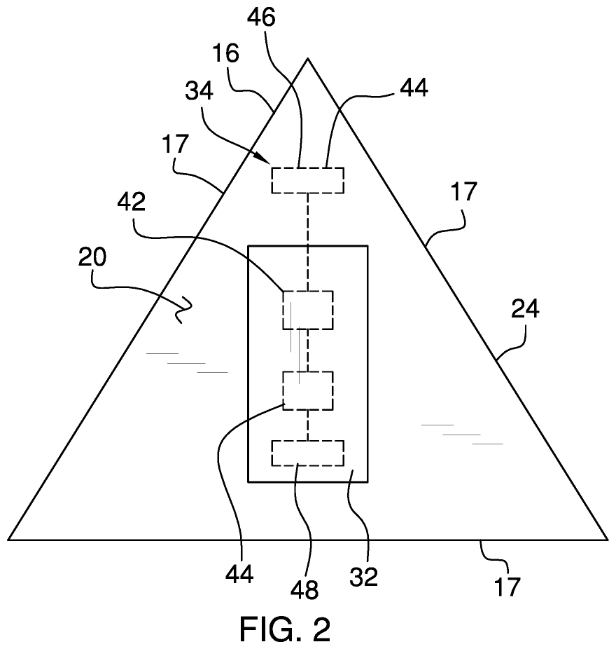

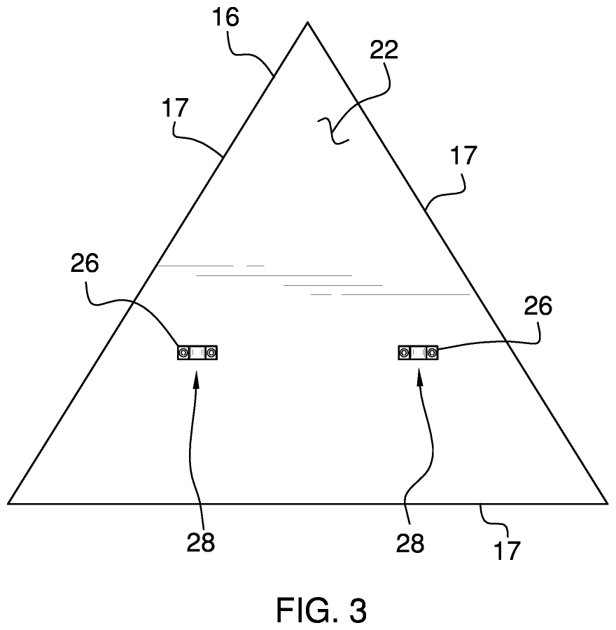

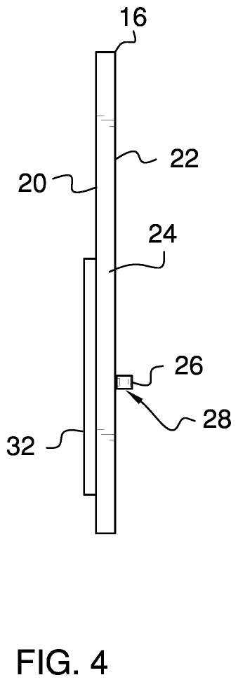

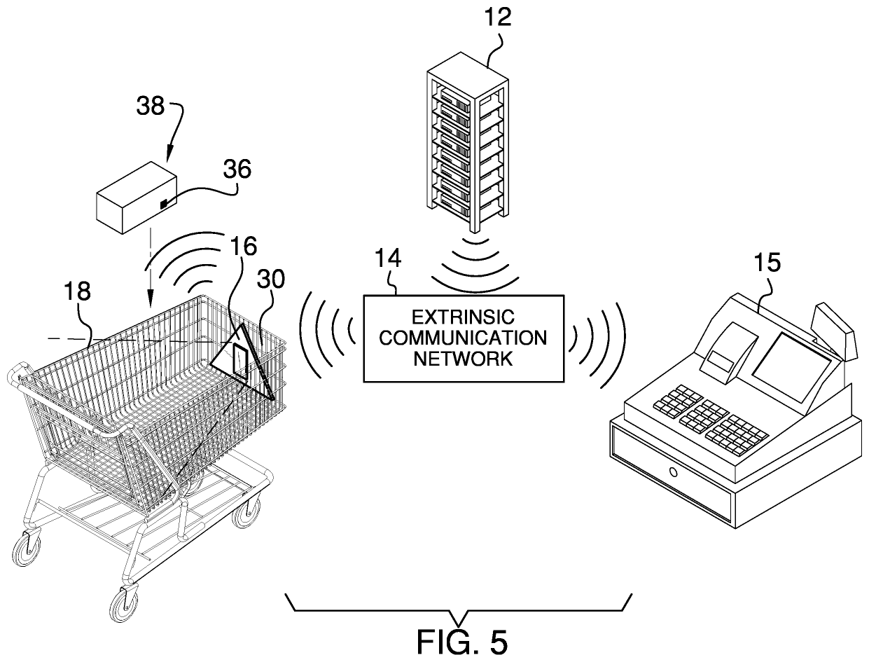

With reference now to the drawings, and in particular to FIGS. 1 through 5 thereof, a new tracking device embodying the principles and concepts of an embodiment of the disclosure and generally designated by the reference numeral 10 will be described.

As best illustrated in FIGS. 1 through 5, the shopping tracking assembly 10 generally comprises a data server 12 that stores a database comprising a list of items being sold in a retail environment. The retail environment may be a grocery store, an electronics store or any other type of retail environment. The data server 12 is in wireless communication with an extrinsic communication network 14 thereby facilitating the data server 12 to be in wireless communication with a point of sale device 15. The extrinsic communication network 14 may be the internet or other type of wireless communication network. Additionally, the data server 12 may be a personal computer or other type of digital information storage device.

A panel 16 is provided that has a plurality of intersecting sides 17 such that the panel 16 has a triangular shape, and the panel 16 is attachable to a shopping cart 18. The panel 16 has a first surface 20, a second surface 22 and a perimeter edge 24 extending therebetween, and each of the intersecting sides 17 is associated with the perimeter edge 24. A pair of fasteners 26 is each coupled to the second surface 22 of the panel 16. Each of the fasteners 26 has an arched portion 28 curving outwardly from the second surface 22 such that the arched portion 28 of each of the fasteners 26 can accommodate a frame 30 of the shopping cart 18 to attach the panel 16 to the frame 30.

A housing 32 is coupled to the panel 16 and the housing 32 is centrally positioned on the first surface 20. The housing 32 is elongated to extend along a line that extends between a base of the triangular shape of the panel 16 and an apex of the triangular shape. A tracking unit 34 is integrated into the housing 32 and the tracking unit 34 is in wireless communication with a tracking device 36 on a retail item 38 that is placed into the shopping cart 18. In this way the tracking unit 34 can identify the retail item 38. The tracking unit 34 is in wireless communication with the data server 12 such that the data server 12 can receive the identity of the retail item 38. In this way the data server 12 can compile a list of each retail item 38 that has been placed into the shopping cart 18.

Moreover, the data server 12 communicates the list of each retail item 38 to a point of sale device 15 when a person who is shopping is paying for the retail item 38. In this way the data server 12 inhibits any retail item 38 from being removed from the retail environment without paying for the retail item 38.

The tracking unit 34 comprises a control circuit 42 that is integrated into the housing 32. The tracking unit 34 includes a transceiver 44 that is integrated into the housing 32. The transceiver 44 broadcasts a reading signal such that the transceiver 44 is in wireless communication with the tracking device 36 on the retail item 38 that is placed into the shopping cart 18. The tracking device 36 may comprise a radio frequency identification device or other type of device that produces an electromagnetic field. The transceiver 44 is electrically coupled to the control circuit 42 and the transceiver 44 communicates tracking data received from the tracking device 36 to the control circuit 42. Additionally, the transceiver 44 may comprise a radio frequency transceiver that is commonly employed for radio frequency identification.

The tracking unit 34 includes a transmitter 46 that is integrated into the housing 32. The transmitter 46 is in wireless communication with the extrinsic communication network 14 thereby facilitating the transmitter 46 to be in communication with the data server 12. Moreover, the transmitter 46 is in communication with the transceiver 44 such that the transmitter 46 can receive the tracking data from the transceiver 44. In this way the data server 12 can receive the tracking data. Additionally, the transmitter 46 is electrically coupled to the control circuit 42, the transmitter 46 may comprise a radio frequency transmitter or the like and the transmitter 46 may employ a WPAN signal such that the transmitter 46 can be wirelessly connected to the internet. The tracking unit 34 includes a power supply 48 is integrated into the housing 32, the power supply 48 is electrically coupled to the control circuit 42 and the power supply 48 comprises at least one battery.

In use, the tracking unit 34 records each retail item 38 that is placed into the shopping cart 18 and the data server 12 compiles a list of each retail item 38 that is placed into the shopping cart 18. The point of sale device 15 receives the list of the retail items 38 in the shopping cart 18 when the person employing the shopping cart 18 is paying for the retail items 38 they intend to purchase. In this way the point of sale device 15 is notified if one or more of the retail items 38 that were placed into the shopping cart 18 have not been paid for. Moreover, the point of sale device 15 does not permit the transaction to be completed until all of the tracked retail items 38 have either been paid for or returned. In this way the retail environment can accurately track inventory and minimize losses incurred by theft or error at the point of sale device 15.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A shopping tracking assembly for compiling a list of items placed in a shopping cart to subsequently reconcile the list of items at a checkout point, said assembly comprising:
a data server storing a database comprising a list of items being sold in a retail environment, said data server being in wireless communication with an extrinsic communication network thereby facilitating said data server to be in wireless communication with a point of sale device;
a panel having a plurality of intersecting sides such that said panel has a triangular shape, said panel being attachable to a shopping cart;
a housing being coupled to said panel such that a peripheral edge of said housing is inset relative to a perimeter edge of said panel; and
a tracking unit being integrated into said housing, said tracking unit being in wireless communication with a. tracking device on a retail item that is placed into the shopping cart wherein said tracking unit is configured to identify the retail item, said tracking unit being in wireless communication with said data server wherein said data server is configured to receive the identity of the retail item thereby facilitating said data server to compile a list of each retail item that has been place into the shopping cart, said data server communicating the list of each retail item to the point of sale device when a person shopping is paying for the retail items wherein said data server is configured to inhibit any retail item from being removed from the retail environment without paying for the retail item.

2. The assembly according to claim 1, wherein:
said panel has a first surface, a second surface and the perimeter edge extending therebetween, each of said intersecting sides being associated with said perimeter edge;
said assembly includes a pair of fasteners, each of said fasteners being coupled to said second surface of said panel, each of said fasteners having a arched portion curving outwardly from said second surface wherein said arched portion of each of said fasteners is configured to accommodate a frame of the shopping cart for attaching said panel to the frame; and
said housing is centrally positioned on said first surface, said housing being elongated to extend along a line extending between a base of said triangular shape of said panel and an apex of said triangular shape.

3. The assembly according to claim 1, wherein said tracking unit comprises:
a control circuit being integrated into said housing; and
a transceiver being integrated into said housing, said transceiver broadcasting a reading signal wherein said transceiver is configured to be in wireless communication with a tracking device on a retail item that is placed into the shopping cart, said transceiver being electrically coupled to said control circuit, said transceiver communicating tracking data received from the tracking device to said control circuit.

4. The assembly according to claim 3, further comprising a transmitter being integrated into said housing, said transmitter being in wireless communication with said extrinsic communication network thereby facilitating said transmitter to be in communication with said data server, said transmitter being in communication with said transceiver wherein said transmitter is configured to receive the tracking data from said transceiver thereby facilitating said data server to receive the tracking data, said transmitter being electrically coupled to said control circuit.

5. A shopping tracking assembly for compiling a list of items placed in a shopping cart to subsequently reconcile the list of items at a checkout point, said assembly comprising:
a data server storing a database comprising a list of items being sold in a retail environment, said data server being in wireless communication with an extrinsic communication network thereby facilitating said data server to be in wireless communication with a point of sale device;
a panel having a plurality of intersecting sides such that said panel has a triangular shape, said panel being attachable to a shopping cart, said panel having a first surface, a second surface and a perimeter edge extending therebetween, each of said intersecting sides being associated with said perimeter edge;
a pair of fasteners, each of said fasteners being coupled to said second surface of said panel, each of said fasteners having a arched portion curving outwardly from said second surface wherein said arched portion of each of said fasteners is configured to accommodate a frame of the shopping cart for attaching said panel to the frame;
a housing being coupled to said panel such that a peripheral edge of said housing is inset relative to the perimeter edge of said panel, said housing being centrally positioned on said first surface, said housing being elongated to extend along a line extending between a base of said triangular shape of said panel and an apex of said triangular shape;
a tracking unit being integrated into said housing, said tracking unit being in wireless communication with a tracking device on a retail item that is placed into the shopping cart wherein said tracking unit is configured to identify the retail item, said tracking unit being in wireless communication with said data server wherein said data server is configured to receive the identity of the retail item thereby facilitating said data server to compile a list of each retail item that has been place into the shopping cart, said data server communicating the list of each retail item to the point of sale device when a person shopping is paying for the retail items wherein said data server is configured to inhibit any retail item from being removed from the retail environment without paying for the retail item, said tracking unit comprising:
a control circuit being integrated into said housing;
a transceiver being integrated into said housing, said transceiver broadcasting a reading signal wherein said transceiver is configured to be in wireless communication with a tracking device on a retail item that is placed into the shopping cart, said transceiver being electrically coupled to said control circuit, said transceiver communicating tracking data received from the tracking device to said control circuit;
a transmitter being integrated into said housing, said transmitter being in wireless communication with said extrinsic communication network thereby facilitating said transmitter to be in communication with said data server, said transmitter being in communication with said transceiver wherein said transmitter is configured to receive the tracking data from said transceiver thereby facilitating said data server to receive the tracking data, said transmitter being electrically coupled to said control circuit; and
a power supply being integrated into said housing, said power supply being electrically coupled to said control circuit, said power supply comprising at least one battery.

6. A shopping tracking system for compiling a list of items placed in a shopping cart to subsequently reconcile the list of items at a checkout point, said system comprising:
a point of sale device being positioned in a retail environment;
a data server storing a database comprising a list of items being sold in a retail environment, said data server being in wireless communication with an extrinsic communication network thereby facilitating said data server to be in wireless communication with a point of sale device;
a shopping cart being positioned in the retail environment wherein said shopping cart is configured to receive retail items for purchase;
a panel having a plurality of intersecting sides such that said panel has a triangular shape, said panel being attachable to said shopping cart, said panel having a first surface, a second surface and a perimeter edge extending therebetween, each of said intersecting sides being associated with said perimeter edge;
a pair of fasteners, each of said fasteners being coupled to said second surface of said panel, each of said fasteners having a arched portion curving outwardly from said second surface, said arched portion of each of said fasteners accommodating a frame of said shopping cart for attaching said panel to said frame;
a housing being coupled to said panel such that a peripheral edge of said housing is inset relative to the perimeter edge of said panel, said housing being centrally positioned on said first surface, said housing being elongated to extend along a line extending between a base of said triangular shape of said panel and an apex of said triangular shape;
a tracking unit being integrated into said housing, said tracking unit being in wireless communication with a tracking device on a retail item that is placed into said shopping cart wherein said tracking unit is configured to identify the retail item, said tracking unit being in wireless communication with said data server wherein said data server is configured to receive the identity of the retail item thereby facilitating said data server to compile a list of each retail item that has been place into said shopping cart, said data server communicating the list of each retail item to said point of sale device when a person shopping is paying for the retail items wherein said data server is configured to inhibit any retail item from being removed from the retail environment without paying for the retail item, said tracking unit comprising:
a control circuit being integrated into said housing;
a transceiver being integrated into said housing, said transceiver broadcasting a reading signal wherein said transceiver is configured to be in wireless communication with a tracking device on a retail item that is placed into the shopping cart, said transceiver being electrically coupled to said control circuit, said transceiver communicating tracking data received from the tracking device to said control circuit;
a transmitter being integrated into said housing, said transmitter being in wireless communication with said extrinsic communication network thereby facilitating said transmitter to be in communication with said data server, said transmitter being in communication with said transceiver wherein said transmitter is configured to receive the tracking data from said transceiver thereby facilitating said data server to receive the tracking data, said transmitter being electrically coupled to said control circuit; and
a power supply being integrated into said housing, said power supply being electrically coupled to said control circuit, said power supply comprising at least one battery.
